(19) United States
(12) Patent Application Publication
(10) Pub. No.: US 2025/0363838 A1
(43) Pub. Date: Nov. 27, 2025

(54) COMPUTER SYSTEM AND METHOD FOR DETERMINING AND DISPLAYING PIVOT POINT OF A VEHICLE

(71) Applicant: VOLVO TRUCK CORPORATION, Göteborg (SE)

(72) Inventors: Nicolas BERNE, Heyrieux (FR); Ciro ONUKI, Curitiba (BR)

(73) Assignee: VOLVO TRUCK CORPORATION, Göteborg (SE)

(21) Appl. No.: 19/176,600

(22) Filed: Apr. 11, 2025

(30) Foreign Application Priority Data
May 21, 2024 (EP) 24177050.2

(51) Int. Cl. G07C 5/08; B60R 1/25; B62D 61/12; G06T 11/00; H04N 7/18

(52) U.S. Cl. CPC G07C 5/0825; B60R 1/25; B62D 61/12; G06T 11/00; H04N 7/181; G06T 2200/24

(57) ABSTRACT

A computer system has processing circuitry configured to process first parameter data associated with a vehicle and the operation of the vehicle to determine a first pivot point of the vehicle, display a first pivot point indicia associated with the first pivot point, process second parameter data associated with the vehicle and the operation of the vehicle to determine a second pivot point of the vehicle changed from the first pivot point, and display a second pivot point indicia associated with the second pivot point.

### TECHNICAL FIELD

The disclosure relates generally to driving assistance systems. In particular aspects, the disclosure relates to a computer system and method for determining and displaying a pivot point of a vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

In the field of vehicles and in particular heavy-duty vehicles, the pivot point of the steering of the vehicle may shift depending on whether or not the driver reverses or drives forward. This may particularly be the case where the vehicle includes one or more articulated trailers. During parking of the vehicle or reversing the vehicle to a dock, the driver may have to drive the vehicle back and forth making it difficult to keep track of where the pivot point of the vehicle is located.

### SUMMARY

According to a first aspect of the disclosure, a computer system is provided. The computer system comprises processing circuitry configured to process first parameter data associated with a vehicle and a first operation of said vehicle to determine a first pivot point of the vehicle; display a first pivot point indicia associated with the first pivot point; process second parameter data associated with the vehicle and a second operation of said vehicle to determine a second pivot point of the vehicle changed from the first pivot point, and display a second pivot point indicia associated with the second pivot point. The first aspect of the disclosure may seek to achieve a computer system allowing for a more user friendly and time efficient maneuvering of the vehicle. A technical benefit may include better indicating the pivot point of the vehicle shifting, allowing for safer, more time efficient and more user friendly maneuvering of the vehicle, particularly during parking or reversing to a dock.

Optionally in some examples, including in at least one preferred example, the vehicle may comprise a trailer.

Optionally in some examples, including in at least one preferred example, the vehicle may comprise one or more articulated trailer and the processing circuitry is configured to determine a first and second pivot point and display a first and second pivot point indicia for each articulated trailer. A technical benefit may include a more time efficient, user friendly and safe maneuvering of a vehicle further taking into account a plurality of articulated trailers.

Optionally in some examples, including in at least one preferred example, the processing circuitry may be configured to process the first and second parameter data to identify a current steering angle of the vehicle and a current driving direction of the vehicle, and wherein the processing circuitry is configured to determine the first and second pivot point based on the current steering angle and the current driving direction of the vehicle. A technical benefit may include that the parameters allows for a more accurate determining pivot point of the vehicle.

Optionally in some examples, including in at least one preferred example, the processing circuitry may be configured to process the first and second parameter data to identify one or more load indicator value associated with the load distribution of the vehicle and based on said one or more load indicator value, determine a load distribution model of the vehicle, and wherein the processing circuitry is configured to determine the first and second pivot point based on said load distribution model. A technical benefit may include that the load distribution model further allows for the pivot point to be determined based on how the vehicle and in particular the vehicle trailers are loaded, allowing for a more accurate determining of the point.

Optionally in some examples, including in at least one preferred example, the one or more load indicator value may comprise at least one of a value associated with the type of wheel axles of the vehicle, number of wheel axles of the vehicle, the position of the wheel axles of the vehicle, the load on the wheel axles of the vehicle, the status of one or more liftable wheel axles of the vehicle, the number of wheels of the vehicle or the tire pressure of the tires of the vehicle.

Optionally in some examples, including in at least one preferred example, the vehicle comprises may comprise a trailer with at least two rear wheel axles and the processing circuitry is configured to process the first and second parameter data to identify a first load indicator value associated with the load on a first rear wheel axle of the trailer and a second load indicator value associated with the load on a second rear wheel axle of the trailer and determine the first and second pivot point based on said first and second load indicator value. A technical benefit may include that a simple and non-complex manner of determining the pivot point may be achieved.

Optionally in some examples, including in at least one preferred example, the processing circuitry may be configured to process the first and second parameter data to identify one or more geometrical indicator value associated with the geometry of the vehicle and based on said one or more geometrical indicator value determine a geometrical model of the vehicle. The processing circuitry may be further configured to determine the first and second pivot point based on said geometrical model. A technical benefit may include that the geometrical model may serve to improve the accuracy of the determining of the pivot point of the vehicle.

Optionally in some examples, including in at least one preferred example, the computer system may further comprise a user interface comprising a display device. The processing circuitry may be configured to display the first and second pivot point indicia on the display device.

According to a second aspect of the disclosure, a vehicle comprising the computer system according to any of the examples described herein may be provided. The second aspect of the disclosure may seek to achieve a vehicle which is more user friendly and time efficient to maneuver. A technical benefit may include that the driver may be provided with an indication of the pivot point of the vehicle shifting, allowing for safer, more time efficient and more user friendly maneuvering of the vehicle, particularly during parking or reversing to a dock.

Optionally in some examples, including in at least one preferred example, the vehicle may further comprise a camera monitoring system configured to monitor a zone in connection to the vehicle and operatively connected to the computer system, wherein the processing circuitry is configured to obtain an image feed from the camera monitoring system and the processing circuitry is configured to display the first and second pivot point indicia as an overlay in said image feed. A technical benefit may include that the pivot point indicia may be presented to the driver in an intuitive manner.

Optionally in some examples, including in at least one preferred example, the camera monitoring system may form a part of a digital side view mirror system and/or a rearview mirror system. A technical benefit may include that the driver may utilize an intuitive way of being presented with the pivot point indicia, e.g. by means of looking at a rearview or side view mirror.

Optionally in some examples, including in at least one preferred example, the computer system may comprise a user interface comprising a display device, wherein the processing circuitry may be configured to display the first and second pivot point indicia on said display device. The vehicle may further comprise a camera monitoring system configured to monitor a zone in connection to the vehicle and operatively connected to the user interface, wherein the display device may be configured to present an image feed from the camera monitoring system and the processing circuitry may be configured to display the first and second pivot point indicia as an overlay in said image feed. The camera monitoring system may form a part of a digital side view mirror and/or rearview mirror system. The vehicle may comprise a trailer and a tractor, wherein the trailer may be connected to the tractor via an articulated connection. The processing circuitry may be configured to process the first and second parameter data to identify a current steering angle of the vehicle and a current driving direction of the vehicle and identify one or more load indicator value associated with the current load distribution of the vehicle and based on said one or more load indicator value determine a load distribution model of the vehicle. The processing circuitry may be configured to determine the first and second pivot point based on the current steering angle and the current driving direction of the vehicle and said load distribution model. A technical benefit may include that the driver may be provided with an indication of the pivot point of the vehicle shifting, allowing for safer, more time efficient and more user friendly maneuvering of the vehicle, particularly during parking or reversing to a dock.

According to a third aspect of the disclosure, a computer-implemented method may be provided. The computer-implemented method comprises processing, by processing circuitry of a computer system, first parameter data associated with a vehicle and a first operation of the vehicle to determine a first pivot point of the vehicle; displaying, by the processing circuitry, a first pivot point indicia associated with the first point; processing, by the processing circuitry, second parameter data associated with the vehicle and a second operation of the vehicle to determine a second pivot point of the vehicle changed from the first pivot point, and displaying, by the processing circuitry, a second pivot point indicia associated with the second pivot point. The third aspect of the disclosure may seek to achieve a method for operating a vehicle allowing for a more user friendly and time efficient maneuvering of the vehicle. A technical benefit may include that the driver may be provided with an indication of the pivot point of the vehicle shifting, allowing for safer, more time efficient and more user friendly maneuvering of the vehicle, particularly during parking or reversing to a dock.

Optionally in some examples, including in at least one preferred example, the vehicle may comprise one or more articulated trailer and the method may further comprise determining, by the processing circuitry, a first and second pivot point for each articulated trailer; and displaying, by the processing circuitry, a first and second pivot point indicia for each articulated trailer. A technical benefit may include a more time efficient, user friendly and safe maneuvering of a vehicle further taking into account a plurality of articulated trailers.

Optionally in some examples, including in at least one preferred example, the method may further comprise processing, by the processing circuitry, the first and second parameter data to identify a current steering angle of the vehicle and a current driving direction of the vehicle, and determining, by the processing circuitry, the first and second pivot point based on the current steering angle and the current driving direction of the vehicle. A technical benefit may include that the parameters allows for a more accurate determining pivot point of the vehicle.

Optionally in some examples, including in at least one preferred example, the method may further comprise processing, by the processing circuitry, the first and second parameter data to identify one or more load indicator value associated with the current load distribution of the vehicle; determining, by the processing circuitry, a load distribution model of the vehicle based on the one or more load indicator value; and determining, by the processing circuitry, the first and second pivot point based on the load distribution model. A technical benefit may include that the load distribution model further allows for the pivot point to be determined based on how the vehicle and in particular the vehicle trailers are loaded, allowing for a more accurate determining of the point.

Optionally in some examples, including in at least one preferred example, the method may further comprise processing, by the processing circuitry, the first and second parameter data to identify one or more geometrical indicator value associated with the geometry of the vehicle; determining, by the processing circuitry, a geometrical model of the vehicle based on said one or more geometrical indicator value; and determining, by the processing circuitry, the first and second pivot point based on said geometrical model. A technical benefit may include that the geometrical model may serve to improve the accuracy of the determining of the pivot point of the vehicle.

According to a fourth aspect of the disclosure, a computer program may be provided. The computer program may comprise program code for performing when executed by the processing circuitry, the method according to any of the examples described herein.

According to a fifth aspect of the disclosure, a non-transitory computer-readable storage medium may be provided. The non-transitory computer-readable storage medium may comprise instructions which when executed by the processing circuitry, may cause the processing circuitry to perform the method according to any of the examples described herein.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary vehicle according to an example.

FIG. 2 is a schematic system diagram of a control system according to an example.

FIG. 3 is a schematic system diagram of the control system of FIG. 2 according to a more detailed example.

FIG. 4 is schematic block diagram of a control system according to an example.

FIG. 5 is a schematic block diagram of a control system and a camera monitoring system according to an example.

FIG. 6 is a schematic block diagram of the camera monitoring system of FIG. 5 in further detail.

FIG. 7 is a flow chart of a method for determining a pivot point according to an example.

FIG. 8 is a flow chart of a more detailed method for determining a pivot point according to an example.

FIG. 9 is a flow chart of a more detailed method for determining a pivot point according to an example.

FIG. 10 is a top view of the operation of a vehicle according to one example.

FIG. 11 is a top view of the operation of a vehicle according to one example.

FIG. 12A-B are exemplary driver views from a vehicle according to one example.

FIG. 13 is an exemplary schematic diagram of a computer program product according to an example.

FIG. 14 is another view of FIG. 2 according to an example.

FIG. 15 is a flow chart of an exemplary method for determining a pivot point according to an example.

FIG. 16 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

The examples presented herein provide a solution to improve the speed and safety of the vehicle, in particular heavy duty vehicles such as trucks etc., which are subjected to the pivot point shifting during operation. By presenting the driver indications of the pivot point of the vehicle shifting, the driver may take this into account during maneuvering of the vehicle, in particular during parking or reversing towards a loading dock.

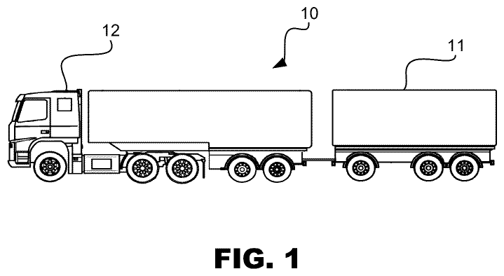

FIG. 1 is an exemplary side view of a vehicle 10 according to one example. The vehicle 10, herein the form of a truck, may or may not be an articulated vehicle. The truck 10 comprises a tractor 12 and a trailer 11 being pulled by the tractor 12. The vehicle 10 is configured to present visual indications representing a pivot point of the vehicle 10, as will be described further in the following.

A pivot point is herein defined as current set point on the vehicle around which the vehicle rotates during turning. The pivot point will remain stationary relative to the vehicle during the turning operation. Commonly, in vehicles with two axles, the pivot point is located at the center of the rear axle. However, this is not always the case, In particular not for vehicles with more than two axles.

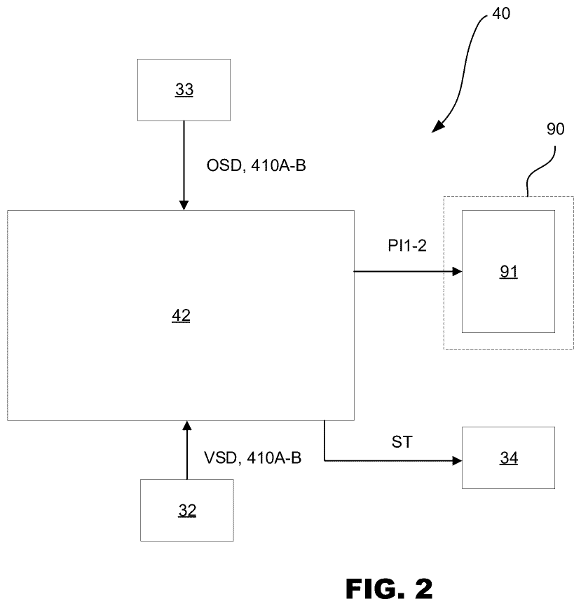

FIG. 2 shows a vehicle 10 in terms of a system diagram of an example of a control system 40 for providing the visual indication representing the pivot point of the vehicle 10.

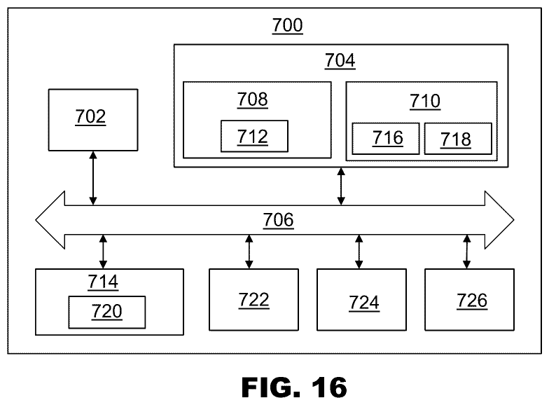

The control system 40 comprises one or more control units 42. The one or more control units 42 is configured to receive data, and to process the data in order to determine the required vehicle characteristics. The one or more control units 42 may be implemented as a processing circuitry 702, see FIG. 16.

The control system 40 is configured to process parameter data 410 associated with the vehicle 10 and the operation of the vehicle 10. The control system 40 may be configured to receive said parameter data 410 to determine the pivot point P of the vehicle 10. The one or more control units 42 may be configured to process the parameter data 410 and receive said parameter data 410 to determine the pivot point P of the vehicle 10.

The one or more control units 42 may be in communication with a vehicle settings collector 32. The vehicle settings collector 32 is configured to store vehicle settings data VSD, and to communicate, preferably in real time, the vehicle settings data VSD to the one or more control units 42. The vehicle settings data VSD may e.g. comprise information relating to fixed vehicle parameters such as vehicle length, tractor unit length, trailer length, fifth wheel position, vehicle width, tractor width, trailer width, tire dimensions, etc., The parameter data 410 may thus comprise the vehicle settings data VSD.

The one or more control units 42 may be in communication with a vehicle operations collector 33. The vehicle operations collector 33 may be configured to obtain operational data OSD associated with the operation of the vehicle 10 such as the speed of the vehicle, the steering angle of the vehicle, the angle of the one or more of the trailers of the vehicle etc. The parameter data 410 may thus comprise the operational data OSD.

The one or more control units 42 is configured to process the parameter data 410 and to determine the pivot point P of the vehicle 10 and display a pivot point indicia PI associated with the pivot point P, as will be further described below. In particular, the pivot point P may be determined based on the vehicle settings data VSD and the operational data OSD.

The pivot point indicia PI for the vehicle 10 is communicated by the one or more control units 42. As shown in FIG. 2, the pivot point indicia PI is communicated by the one or more control units 42 to a user interface 90. The user interface 90 may comprise a display device 91. The display device 91 may be configured to display the pivot point indicia PI. The one or more control units 42 may be configured to display the pivot point indicia PI on the display device 91. The display device 91 may e.g. comprise a head-up display HUD or an augmented reality display configured to display visual information. The visual information may comprise the pivot point indicia PI.

The one or more control units 42 may be configured to determine a change in the pivot point P of the vehicle 10. Accordingly, the one or more control units 42 may be configured to process first parameter data 410A, determine a first pivot point P1 of the vehicle 10 and display a first pivot point indicia PI1 associated with the first pivot point P1. Further, the one or more control units 42 may be configured to process second parameter data 410B, determine a second pivot point P2 of the vehicle 10 changed from the first pivot point P1 and display a second pivot point indicia PI2 associated with the second pivot point P2. The one or more control units 42 may thus be configured to based on the parameter data 410 determine a change in the pivot point P of the vehicle 10 and display a pivot point indicia PI based on said change of pivot point P.

The first parameter data 410A may be associated with the vehicle 10 and a first operation of the vehicle 10. The second parameter data 410B may be associated with the vehicle 10 and a second operation of the vehicle 10.

The first parameter data 410A may be parameter data associated with the vehicle 10 and the first operation of the vehicle 10 at a first point in time and the second parameter data 410B may be parameter data associated with the vehicle 10 and the second operation of the vehicle 10 at a second point in time distinguished from the first point in time.

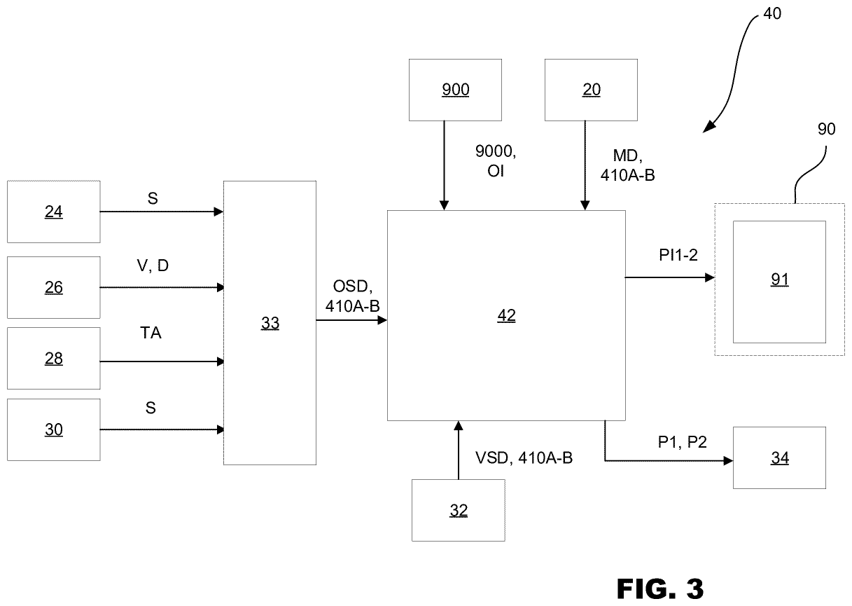

FIG. 3 shows the vehicle 10 of FIG. 2 according to an example in terms of a system diagram of a control system 40 for providing the visual indication representing the pivot point of the vehicle 10.

The control system 40 comprises the one or more control units 42. The one or more control units 42 is configured to receive data, and to process the data in order to determine the required vehicle characteristics. The one or more control units 42 may be implemented as a processing circuitry 702, see FIG. 16.

In the depicted example, the one or more control unit 42 may be configured to be operatively connected to an adaptive steering system 34 of the vehicle 10. The pivot point P may be communicated to the adaptive steering system 34. The adaptive steering system 34 may also receive real-time information about the actual course of the vehicle 10, for example by receiving operational data OSD from the vehicle operations collector 33. If the actual course of the vehicle 10 departs from a suggested trajectory based on the determined pivot point P, the adaptive steering system 34 may control a steering wheel feedback to the driver, thereby directing the driver to follow the suggested trajectory rather than choosing another route.

The operational data OSD may comprise first operational data associated with the first operation of the vehicle 10 and second operational data associated with the second operation of the vehicle 10.

The one or more control units 42 may be configured to process the parameter data 410 to identify a current steering angle and a driving direction of the vehicle 1. The one or more control units 42 may be configured to determine the pivot point P based on the current steering angle and the current driving direction of the vehicle 10. In one example, the one or more control units 42 may be configured to process the operational data OSD to identify said current steering angle and driving direction.

The one or more control units 42 may be configured to obtain the operational data OSD via the vehicle operations collector 33. The vehicle operations collector 33 may be in communication with one or more sensors for obtaining sensor data relating to the operation of the vehicle 10.

The one or more control units 42 may be in communication with a steering wheel angle sensor 24. The steering wheel angle sensor 24 is configured to communicate, preferably in real time, an actual steering wheel angle which may define the current steering angle S to the one or more control units 42. The one or more control units 42 may be configured to obtain the current steering angle S via the vehicle operations collector 33. The vehicle operations collector 33 may be configured to obtain the current angle S from said steering wheel angle sensor 24.

The one or more control units 42 may be in communication with a vehicle speed sensor 26. The vehicle speed sensor 26 may be configured to communicate, preferably in real time, the actual vehicle speed V of the vehicle 10 to the one or more control units 42. The vehicle speed sensor may be configured to communicate, preferably in real time, the current driving direction D of the vehicle 10. The one or more control units 42 may be configured to obtain the current actual vehicle speed V and/or the current driving direction D via the vehicle operations collector 33. The vehicle operations collector 33 may be configured to obtain the current actual vehicle speed V and/or the current driving direction D from said vehicle speed sensor 26.

The one or more control units 42 is further in communication with a trailer angle sensor 28. The trailer angle sensor 28 is configured to communicate, preferably in real time, the trailer angle TA to the one or more control units 12. The one or more control units 42 may be configured to obtain the trailer angle TA via the vehicle operations collector 33. The vehicle operations collector 33 may be configured to obtain the trailer angle TA from said trailer angle sensor 28. In the event of the vehicle 10 comprising a plurality of trailers, the trailer angle sensor 28 may comprise a plurality of sensing devices such that said trailer angle sensor 28 is configured to communicate the trailer angle TA of each trailer of the vehicle 10.

In one example, the one or more control units 42 may be configured to process the parameter data 410 to identify the trailer angle TA of one or more articulated trailers of the vehicle 10. The one or more control units 42 may be configured to determine the pivot point P based on the trailer angle TA. In one example, the one or more control units 42 may be configured to process the operational data OSD to identify the trailer angle TA. In one example, the pivot point P may be determined based on the trailer angle TA and the current steering angle S and/or the current driving direction of the vehicle 10.

The one or more control units 42 is further in communication with a yaw rate sensor 30. The yaw rate sensor 30 is configured to communicate, preferably in real time, the actual yaw rate which may define the current steering angle S to the one or more control units 12. The one or more control units 42 may be configured to obtain the current steering angle S via the vehicle operations collector 33. The vehicle operations collector 33 may be configured to obtain the current angle S from said yaw rate sensor 30.

The vehicle 10 may comprise a camera monitoring system 900. The camera monitoring system 900 may be configured to monitor a zone in connection to the vehicle 10. The one or more control units 42 may be configured to obtain an image feed 9000 from the camera monitoring system 900. The one or more control units 42 may be configured to display the pivot point indicia PI as an overlay in the image feed 9000. The one or more control units 42 may thus be in communication with the camera monitoring system 900. The camera monitoring system 900 is configured to communicate the image feed 9000 to the one or more control units 42. The image feed 9000 may typically comprise real time characteristics of the road ahead and/or behind the vehicle 10 such as lines and trajectory, as well as real time characteristics of the position of the vehicle 10 on the road.

In an example, the one or more control units 42 may be further configured to determine, preferably in real time, obstacle information OI from the image feed 9000. Optionally, such obstacle information OI may be provided directly, preferably in real time, from the camera monitoring system 900, as illustrated in FIG. 3. The obstacle information OI may comprise information representing a presence of an obstacle on the road ahead of the vehicle 10 or behind the vehicle 10.

In an example, the one or more control units 42 may be in communication with a map data system 20. The map data system 20 is configured to communicate map data MD to the one or more control units 42. The map data MD may typically comprise information relating to the road ahead of the vehicle 10, such as road curvature, road width, road inclination and various dimensions of the road and surrounding buildings, etc. As the vehicle 10 is running, the map data MD is preferably updated in real time as the road ahead of the vehicle changes. In one example, the parameter data 410 may comprise map data MD. The one or more control unit 42 may be configured to process the parameter data to identify road data relating to the road on which the vehicle 10 is travelling. Such road data may include road inclination. The pivot point P of the vehicle may be determined based on said road data.

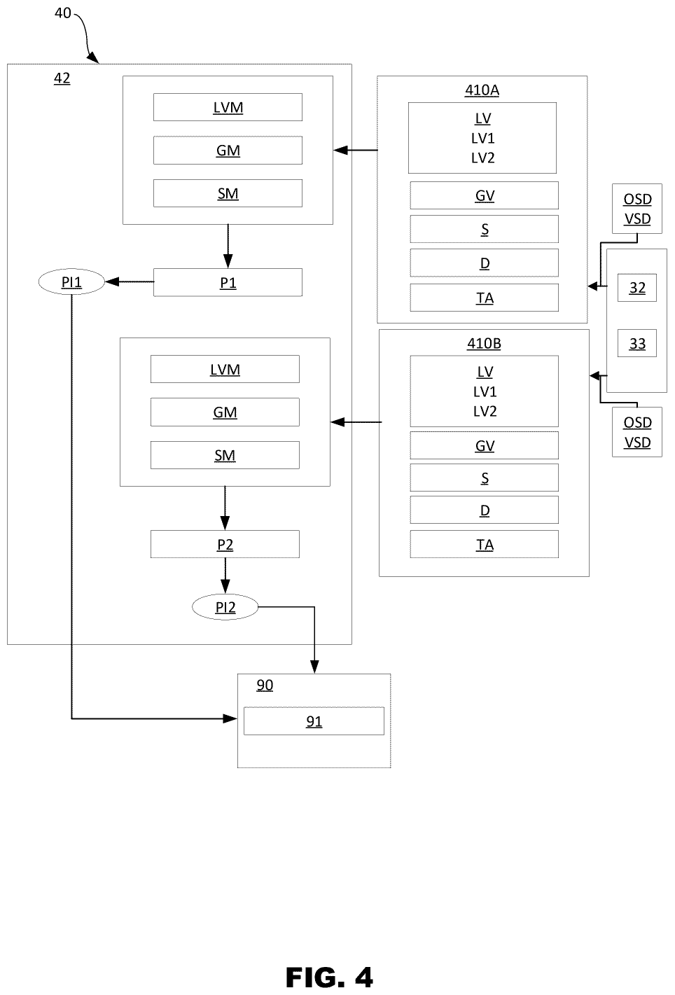

As will be described with reference to FIG. 4, the data described with reference to FIG. 2-3 may according to different examples be utilized for determining a pivot point P of the vehicle 10 and/or displaying a pivot point indicia PI associated with the pivot point P.

FIG. 4 depicts a block diagram of an example of the control system of FIG. 2-3. The one or more control units 42 of the control system 40 may be configured to execute the examples referenced herein.

In an example, the one or more control units 42 may be configured to process the parameter data 410 to identify one or more load indicator value LV. The load indicator value LV may be associated with the load distribution of the vehicle 10. Based on the one or more load indicator value LV, the one or more control unit 42 may be configured to determine a load distribution model LVM of the vehicle 10. The one or more control unit 42 may be configured to determine the pivot point P based on the load distribution model LVM. The one or more load indicator value LV be obtained from the vehicle operations collector 33 and/or the vehicle settings collector 32. As depicted in FIG. 4, a load distribution model LVM may be determined based on the first and second parameter data 410A-B, respectively.

In an example, the parameter data may comprise the operational data OSD and the vehicle settings data VSD provided by the vehicle settings collector 32 and the vehicle operations collector 33. The one or more control units 42 may be configured process the vehicle settings data and the operational data to identify load indicator values LV and determine the load distribution model LVM based on said load indicator values.

The one or more load indicator values LV may comprise at least one of a value associated with the type of wheel axles of the vehicle 10, number of wheel axles of the vehicle 10, the position of the wheel axles of the vehicle 10, the load on the wheel axles of the vehicle 10, the status of one or more liftable wheel axles of the vehicle 10, the number of wheels of the vehicle 10 or the tire pressure of the tires of the vehicle 10.

The one or more control units 42 may be configured to process the vehicle settings data VSD to identify the at least one value associated with the type of wheel axles of the vehicle 10, number of wheel axles of the vehicle 10, the position of the wheel axles of the vehicle 10 and/or the number of wheels of the vehicle 10.

The one or more control units 42 may be configured to process the operational data OSD to identify the at least one value associated with the load on the wheel axles of the vehicle 10, the status of one or more liftable wheel axles of the vehicle 10, and/or the tire pressure of the tires of the vehicle 10.

In one example, the one or more control units 42 may be configured to determine the load distribution model LVM based on load indicator values LV associated with the load on each wheel axle of the vehicle 10 and the weight of vehicle 10. In one example, the load distribution model LVM may be based on the weight of the trailer 11 and the tractor 12. In one example, the one or more control units 42 may be configured to obtain the weight of the vehicle 10, and preferably the weight of the trailer 11 and the tractor 12, from the vehicle settings collector 32 and obtain the load indicator values LV associated with the load on each wheel axle of the vehicle 10 from the vehicle operations collector 33. The one or more control units 42 may be configured to determine load distribution model LVM based on said data and determine the pivot point P based on the load distribution model LVM. Changes in the load distribution of the vehicle 10 may be detected due to corresponding changes in the load distribution model LVM allowing for a new and changed pivot point to be determined.

The one or more control units 42 may be configured to process the parameter data 410 to identify one or more geometrical indicator value GV. The one or more geometrical indicator value GV may be associated with the geometry of the vehicle 10. The one or more control units 42 may be configured to determine a geometrical model GM of the vehicle 10 based on the at least one geometrical indicator value GV. The one or more control units 42 may be configured to determine the pivot point P based on the geometrical model GM. The one or more geometrical indicator value may be obtained from the vehicle settings collector 32. As depicted in FIG. 4, a geometrical model GM may be determined based on the first and second parameter data 410A-B, respectively. It may however be envisioned that the geometrical model GM is static and does not change between the first and second parameter data.

The one or more control units 42 may be configured process the vehicle settings data VSD to the one or more geometrical indicator value GV and determine the geometrical model GM based on said load indicator values.

The one or more geometrical indicator value GV may comprise at least one of a value associated with the length of the vehicle 10, the width of the vehicle 10, the dimensions of a trailer of the vehicle 10 etc.

In one example, the one or more geometrical indicator value GV may comprise the number tires or wheels of vehicle 10 and the relative position of each tire or wheel. The geometrical indicator values GV may thus comprise the position of each wheel or tire relative a coordinate system of the vehicle 10. Due to the pivot point P being related to the points of engagement between the road and the vehicle 10 formed by the wheels/tires, the accuracy of the determined pivot point P may be increased by taking the position of each wheel or tire into account in the determining of the pivot point P.

Advantageously, the pivot point P is determined based on the geometrical model GM and the load distribution model LVM.

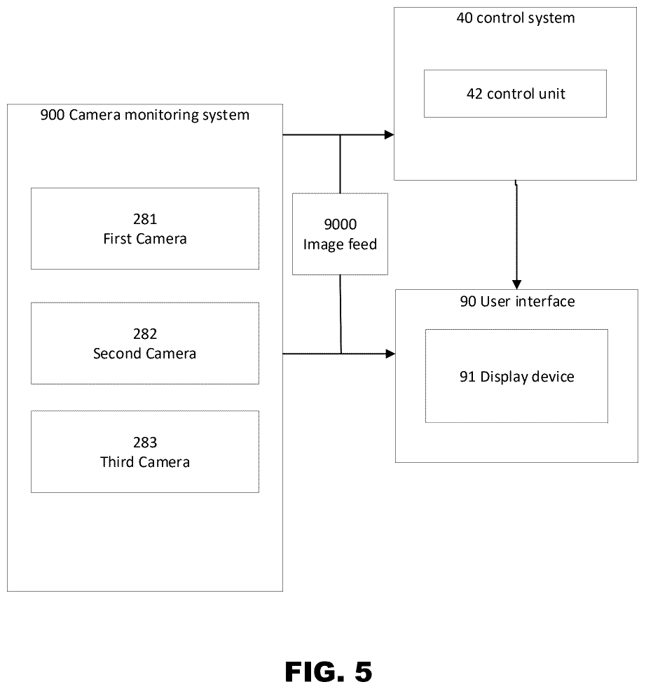

FIG. 5 depicts aspects of a camera monitoring system according to an example. The camera monitoring system 900 may comprise one or more cameras 281-3. The one or more cameras may be configured to monitor a zone at the vehicle 10. The one or more cameras 281-3 may be configured to capture the image feed 9000. As previously described, the camera monitoring system 9000 may be configured to communicate with the control system 40. The camera monitoring system 9000 may be further configured to communicate with the user interface 90 to cause the display device 91 to present the image feed 9000. The display device 91 may thus be configured to display the image feed 9000 obtained by the one or more cameras 281-3.

In an example, the one or more control units 42 may be configured to display the pivot point indicia PI, e.g. the first pivot point indicia PI1 and the second pivot point indicia PI2, as an overlay in the image feed 9000 via the display device 91. The display device 91 may thus be configured to display the image feed 9000 with a graphical overlay based on said pivot point indicia PI.

In the depicted example, the camera monitoring system 900 comprises a first camera 281, a second camera 282 and a third camera 283. The first camera 281 may be configured to monitor a zone extending along a first longitudinal side of the vehicle 10. The second camera 282 may be configured to monitor a zone extending along a second longitudinal side of the vehicle 10, opposite to the first. The third camera 283 may be configured to monitor a zone at the rear side of the vehicle 10. Of course, fewer or more cameras may be used.

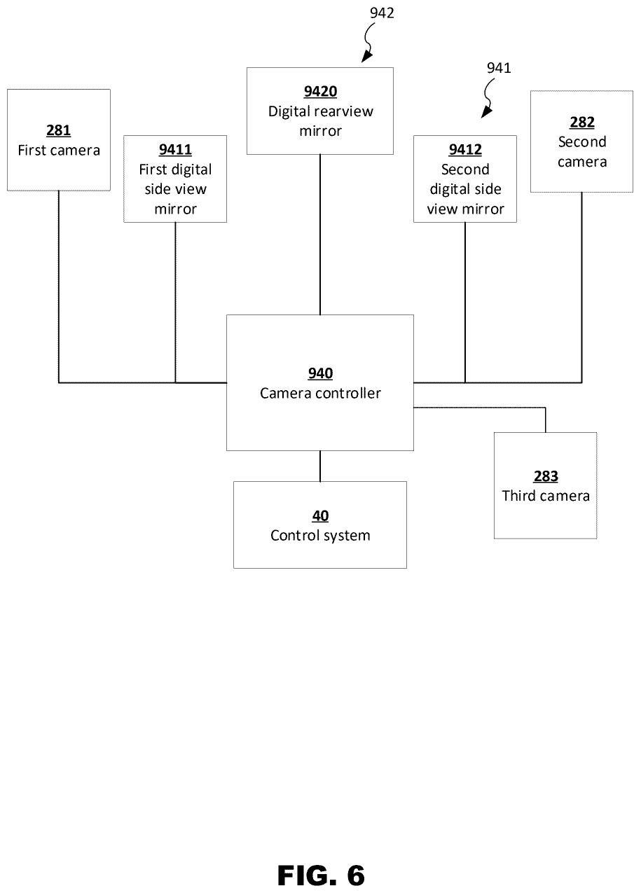

FIG. 6 depicts a system diagram further depicting additional aspects of the camera monitoring system of FIG. 5 of an example.

The camera monitoring system 900 may form a part of a digital side view mirror system 941 and/or a digital rearview mirror system 942.

The digital rearview mirror 9420 of the digital rearview mirror system 942 and/or the one or more digital side view mirror 9411, 9412 may be configured to obtain and display the image feed 9000. The cameras of the camera monitoring system 900 may be positioned at any position suitable for monitoring the zones proximal to the vehicle 10.

In one example, the first camera 281 may be configured to monitor a zone including a first longitudinal side of the vehicle 10. A second camera 282 may be configured to monitor a zone including a second longitudinal side of the vehicle 10. In the depicted example, the first camera 281 is operatively connected to a first digital side view mirror 9411 configured to display an image feed captured by the first camera 281. The second camera 282 may be operatively connected to a second digital side view mirror 9412 configured to display an image feed captured by the second camera 282. It may also be envisioned that a single camera may be utilized in order to monitor a zone including both said first and second longitudinal side of the vehicle 10.

In one example, the third camera 283 may be configured to monitor a zone at the rear of the vehicle 10. In the depicted example, the third camera 283 may be operatively connected to a digital rear view mirror 9420 configured to display an image feed captured by the third camera 283.

The camera monitoring system 900 may comprise a camera controller 940 operatively connected to the one or more cameras 281-3 and the digital rear view mirror 9420 and/or the one or more digital side view mirrors 9411, 9412. The camera controller 940 may be in communication with the control system 40 to send the image feed 9000 to the control system 40. The camera controller 940 may comprise processing circuitry configured to obtain an image feed from each of the cameras of the camera monitoring system 900 and transmit said image feed to the control system 40 and to the one or more digital side rear view mirrors and/or digital rear view mirror.

The one or more digital side rear view mirror 9411, 9412 and/or digital rear view mirror 9420 may accordingly form a part of the user interface 91 previously referenced herein.

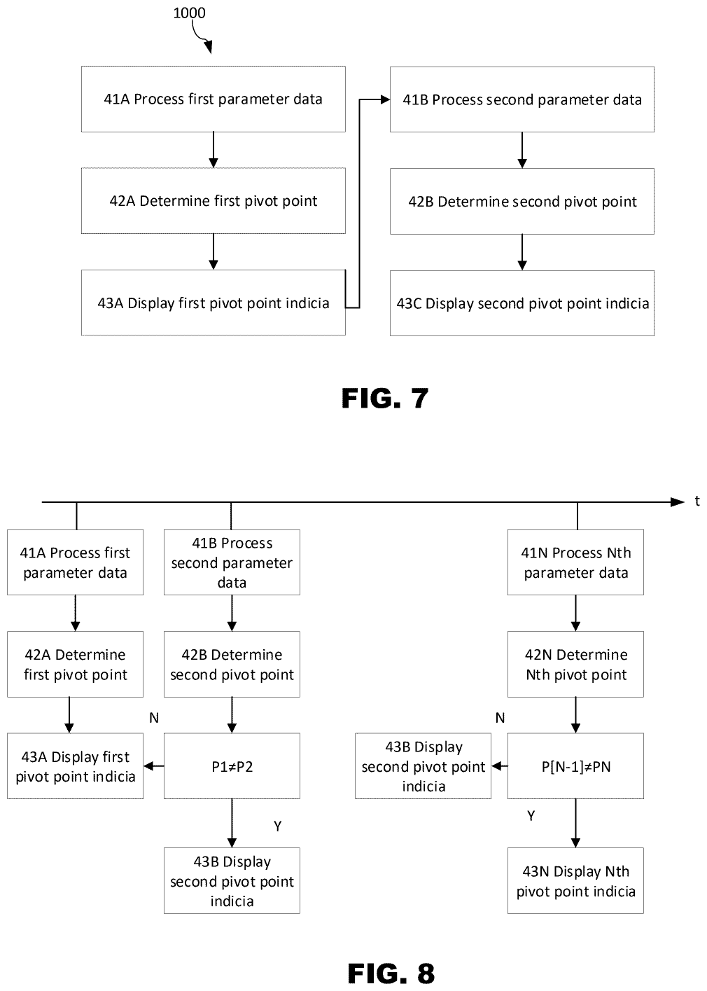

FIG. 7 is a flow chart of a method 1000. The method 1000 may be considered a method of determining a pivot point of a vehicle. The method 1000 comprises processing 41A, by the processing circuitry 42, 702, first parameter data 410A associated with the vehicle 10 and the first operation of the vehicle 10 to determine 42A a first pivot point P1 of the vehicle 10. The method 1000 further comprises displaying 43A, by the processing circuitry 42,702, the first pivot point indicia PI1 associated with the first pivot point P1. The method further comprises 41B, by the processing circuitry 42, 702, second parameter data 410B associated with the vehicle 10 and the second operation of the vehicle 10 to determine 42B a second pivot point P2 of the vehicle 10. The second pivot point P2 is changed from the first pivot point P1. The method 1000 further comprises displaying 43B, by the processing circuitry 42, 702, a second pivot point indicia PI2 associated with the second pivot point P2.

FIG. 8 is a flow chart of a method 1000 of determining a pivot point of the vehicle according to a more detailed example. The method comprises determining the pivot point for a number of points in time to keep track of the pivot point of the vehicle changing during operation of the vehicle.

Referencing FIG. 8, the pivot point may be determined at a first point in time and a second pivot point at a second point in time. Responsive to the second pivot point P2 being changed from the first pivot point P1, the second pivot point indicia PI2 may be displayed. Responsive to the pivot point remaining unchanged, i.e. the first pivot point P1 being identical to the second pivot point P2, the first pivot point indicia PI1 is continued to be displayed.

The method may thus comprise to continuously determine the pivot point P to identify whether said pivot point P has changed. Responsive to a change in pivot point P, a pivot point indicia PI is displayed accordingly.

It may however be envisioned that the pivot point P is determined at a predefined frequency. Additionally or alternatively, the determining of the pivot point P may be triggered by the parameter data 410 for example indicating a loading/unloading operation changing the load distribution of the vehicle 10, a change in driving direction of the vehicle 10 and/or a start of the vehicle 10.

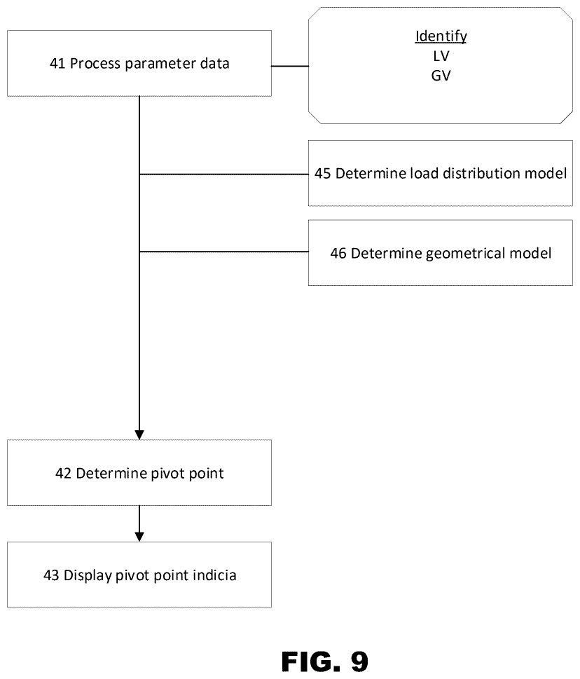

FIG. 9 is a flow chart of a method 1000 of determining a pivot point of the vehicle according to a more detailed example.

The method 1000 may comprise processing 41A-B, by the processing circuitry 42, 702, the first and second parameter data 410A-B to identify the current steering angle S of the vehicle 10 and the current driving direction D of the vehicle 10. The method 1000 may further comprise determining, by the processing circuitry 42, 702, the first pivot point P1 and the second pivot point P2 based on the current steering angle S and the current driving direction D of the vehicle 10.

In an example, the method 1000 may comprise processing 41A-B, by the processing circuitry 42, 702, the first and second parameter data 410A-B to identify one or more load indicator value LV associated with the current load distribution of the vehicle 10. The method 1000 may further comprise determining 45A-B, by the processing circuitry 42, 702, a load distribution model LVM of the vehicle 10 based on the one or more load indicator value LV and determining 42A-B, by the processing circuitry 42, 702, the first pivot point P1 and the second pivot point P2 based on the load distribution model LVM.

In an example, the method 1000 may comprise processing 41A-B, by the processing circuitry 42, 702, the first and second parameter data 410A-B to identify one or more geometrical indicator value GV associated with the geometry of the vehicle 10. The method 1000 may further comprise determining 46A-B, by the processing circuitry 42, 702, a geometrical model GM of the vehicle 10 based on the one or more geometrical indicator value GV. The method 1000 may further comprise determining 42A-B, by the processing circuitry 42, 702, the first pivot point P1 and the second pivot point P2 based on the geometrical model GM.

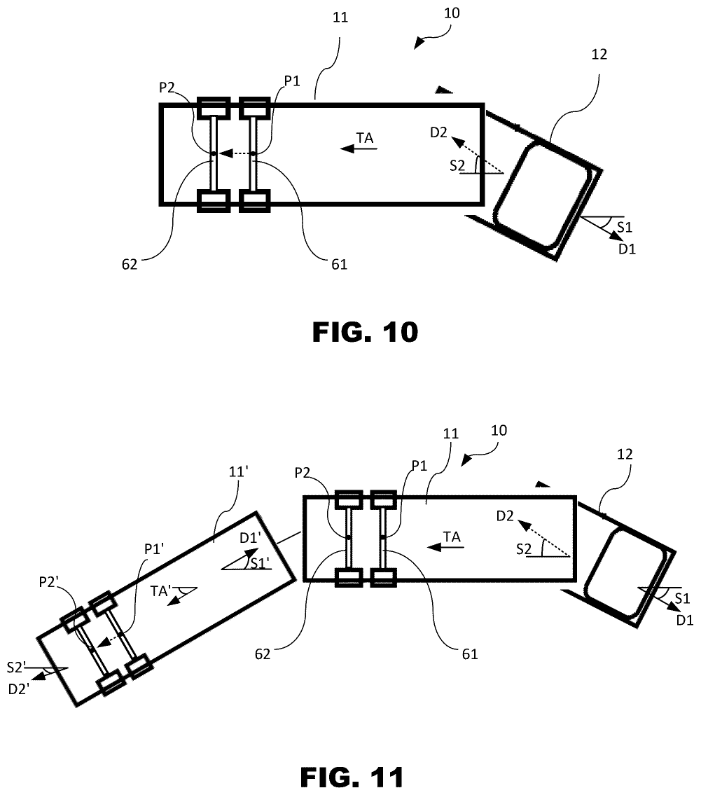

Now turning to FIGS. 10-12 some examples of the method 1000 in operation will be described. In FIG. 10, a vehicle 10 is travelling on a road. The vehicle 10 comprises an articulated trailer 11. The vehicle 10 may comprise a control system 40 and one or more control unit 42 as described with reference to FIGS. 2-4, configured to determine a pivot point P and display a pivot point indicia PI. The vehicle 10 comprises a trailer 11, which may be an articulated trailer. In the depicted example, the trailer 11 comprises has at least two rear wheel axles 61, 62.

At a first point in time, the vehicle 10 may travel in the driving direction D1 and has a current steering angle S1, e.g. have a first driving direction D1 and a first current steering angle S1. The control system 40, e.g. the one or more control units 42, may be configured to determine the pivot point P at the first point in time, e.g. the first pivot point P1, based on said driving direction D1 and current steering angle S1. The control system 40, e.g. the one or more control units 42, may be configured to display a first pivot point indicia PI2 associated with the first pivot point P1 to provide the driver an indication of the first pivot point P1. To further improve the accuracy of the determined pivot point P1 the trailer angle TA, e.g. a current trailer angle, of the trailer 11 may be taken into account.

At a second point in time, the vehicle 10 may start to reverse the vehicle. Thus, the driving direction and current steering angle changes. At the second point in time, the vehicle has a current steering angle S2 and a driving direction D2, e.g. a second current steering angle S2 and a second driving direction D2. The control system 40, e.g. the one or more control units 42, may be configured to determine the pivot point P at the second point time, e.g. the second pivot point P2, based on said driving direction D2 and current steering angle S2. Due to the change in steering angle and driving direction, the pivot point of the vehicle 10 have shifted such that the second pivot point P2 is distinguished from the first pivot point P1. In FIG. 10, this change in pivot point from the first pivot point P1 to the second pivot point P2 is indicated by the dotted arrow. The control system 40, e.g. the one or more control units 42, may be configured to display a second pivot point indicia PI2 associated with the second pivot point P2 to prove the driver an indication of the second pivot point P2. To further improve the accuracy of the determined pivot point P2 the trailer angle TA, e.g. a current trailer angle, of the trailer 11 may be taken into account.

Additionally or alternatively, to the above, the control system 40, e.g. the one or more control units 42, may be configured to process the parameter to identify a first load indicator value associated with the load on the first rear wheel axle 61 of the trailer 11 and a second load indicator value associated with the load on the second rear wheel axle 62. The pivot point may be determined based on said first and second load indicator value. The load distribution between the first and second rear wheel axle 61, 62 may serve as an approximation of the load distribution of the vehicle 10 and in turn the where the pivot point of the vehicle 10 is located. At the first point in time, the first pivot point P1 may be determined based on a first and second load indicator value associated with the load on the first and second rear wheel axle 61, 62, respectively at the first point in time. At the second point in time, the second pivot point P2 may be determined based on a first and second load indicator value associated with the load on the first and second rear wheel axle 61, 62 at the second point in time.

The control system 40, e.g. the one or more control units 42, may be configured to determining a first and second pivot point P1, P2 for each articulated trailer 11 of the vehicle 10 and displaying a first and second pivot point P1, P2 for each articulated trailer 11 of the vehicle 10.

In FIG. 11, the vehicle 10 comprises two articulated trailers. In FIG. 11, a vehicle 10 is travelling on a road. The vehicle 10 comprises two articulated trailers 11 and 11′. The vehicle 10 may comprise a control system 40 and one or more control unit 42 as described with reference to FIGS. 2-4, configured to determine a pivot point P and display a pivot point indicia PI. The vehicle 10 comprises trailers 11 and 11′, which are two articulated trailers.

At a first point in time, the vehicle 10 travels in the driving direction D1 and has a current steering angle S1 and current trailers angles TA and TA′. The control system 40, e.g. the one or more control units 42, may be configured to determine the pivot point P at the first point in time, e.g. the first pivot point P1, based on said driving direction D1 and current steering angle S1 and potentially the trailers angles TA and TA′. The control system 40, e.g. the one or more control units 42, may be configured to display a first pivot point indicia PI1 associated with the first pivot point P1 to provide the driver an indication of the first pivot point P1 of each of the trailers 11, 11′.

At a second point in time, the vehicle 10 may start to reverse the vehicle. Thus, the driving direction and current steering angle and trailer angles change. At the second point in time, the vehicle has a current steering angle S2 and a driving direction D2 and trailers angles TA and TA′. The control system 40, e.g. the one or more control units 42, may be configured to determine the pivot point P at the second point time, e.g. the second pivot point P2, based on said driving direction D2 and current steering angle S2 and potentially the trailer angles TA and TA′. Due to the change in steering angle and driving direction, the pivot point of the vehicle 10 have shifted such that the second pivot point P2 is distinguished from the first pivot point P1. In FIG. 11, this change in pivot point from the first pivot point P1 to the second pivot point P2 is indicated by the dotted arrow. The control system 40, e.g. the one or more control units 42, may be configured to display a second pivot point indicia PI2 associated with the second pivot point P2 to prove the driver an indication of the second pivot point P2 of each of trailers 11, 11′.

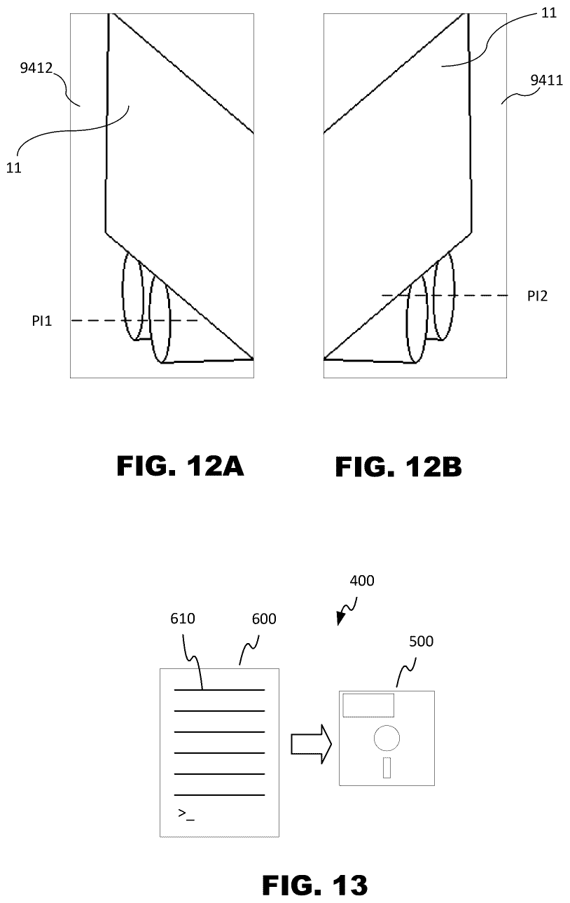

FIG. 12A-B depicts a driver's view in a digital side view mirror or a digital side view mirror system according to an example.

The display device which forms a part of the digital side view mirror system shows in image feed of a zone extending along a longitudinal side of the vehicle 10 and in this case the trailer 11 of the vehicle 10.

In FIG. 12A, the vehicle 10 may be moving forwards and may turn slightly to the right relative the longitudinal axis of the vehicle 10. Based on the steering angle and the direction of the vehicle 10 a pivot point is determined and a pivot point indicia PI1 is displayed. In the depicted example, the vehicle turns right, resulting in the pivot point indicia PI1 being displayed as an overlay in the right digital side view mirror 9412. In the depicted example, the pivot point indicia PI1 is displayed in the form of a dotted line aligning with the determined pivot point of the vehicle 10. It may however be envisioned that the pivot point indicia PI1 may be provided in any form suitable for providing a driver an indication of the location of the pivot point.

In FIG. 12B, the driver has started to reverse the vehicle 10 and turning slightly to the left relative the longitudinal axis of the vehicle 10. Based on the steering angle and the direction of the vehicle 10 a pivot point is determined and a pivot point indicia PI2 is displayed. In the depicted example, the vehicle turns left, resulting in the pivot point indicia PI1 being displayed as an overlay in the left digital side view mirror 9411. In the depicted example, the pivot point indicia PI2 is displayed in the form of a dotted line aligning with the determined pivot point of the vehicle 10.

In FIG. 13 a computer program product 400 is shown. The computer program product 400 comprises a computer program 600 and a non-transitory computer readable medium 500. The computer program 600 may be stored on the computer readable medium 500. The computer readable medium 500 is, in FIG. 11, exemplified as a vintage 5,25″ floppy disc, but may be embodied as any suitable non-transitory computer readable medium such as, but not limited to, hard disk drives (HDDs), solid-state drives (SSDs), optical discs (e.g., CD-ROM, DVD-ROM, CD-RW, DVD-RW), USB flash drives, magnetic tapes, memory cards, Read-Only Memories (ROM), network-attached storage (NAS), cloud storage etc.

The computer program 600 comprises instruction 610 e.g. program instruction, software code, that, when executed by processing circuitry cause the processing circuitry to perform the method 1000 introduced with reference to FIG. 7-FIG. 9.

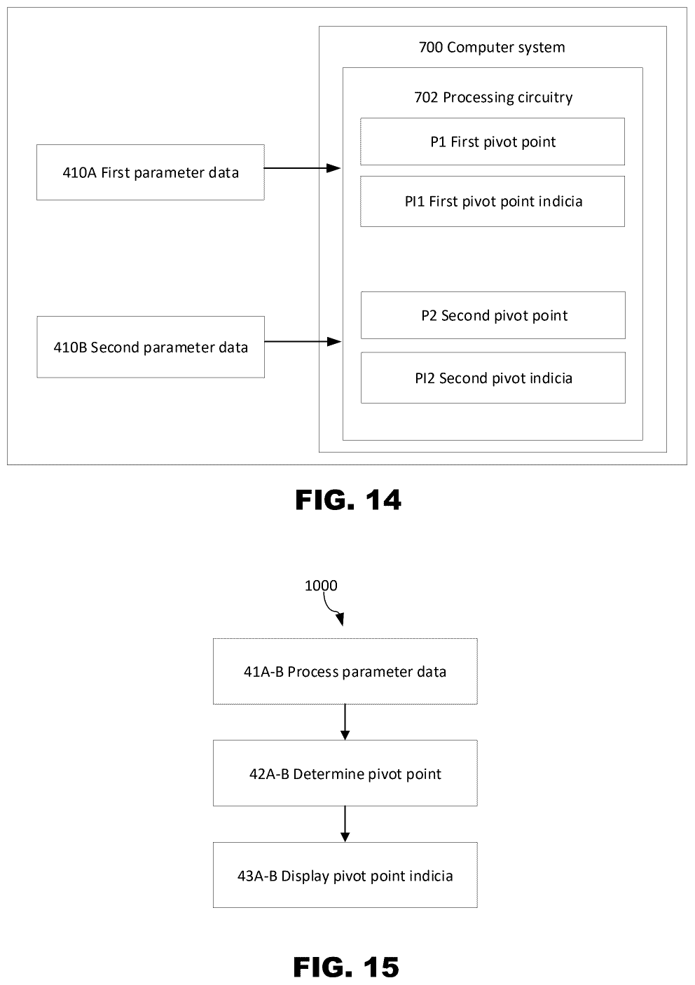

FIG. 14 is another view of FIG. 2, according to an example. FIG. 14 depicts a computer system 700. The computer system 700 may be implemented as the previously described control system 40. The computer system 700 comprises processing circuitry 702 which may be implemented as the previously described one or more control units 42. The processing circuitry 702 is configured to process first parameter data 410A associated with the vehicle 10 and the first operation of said vehicle 10 to determine a first pivot point P1 of the vehicle 10. The processing circuitry 702 is configured to display a first pivot point indicia PI1 associated with the first pivot point P1. The processing circuitry 702 is further configured to process second parameter data 410B associated with the vehicle 10 and the second operation of said vehicle 10 to determine a second pivot point P2 of the vehicle 10 changed from the first pivot point P1. The processing circuitry 702 is configured to display a second pivot point indicia PI2 associated with the second pivot point P2.

FIG. 15 is a flow chart of a computer-implemented method 1000 according to an example. The computer-implemented method comprises processing 41A, by processing circuitry 702, first parameter data 410A associated with the vehicle 10 and the first operation of the vehicle 10 to determine 42A a first pivot point P1 of the vehicle 10 and displaying 43A, by the processing circuitry 702, a first pivot point indicia PI1 associated with the first pivot point P1. The computer-implemented method 1000 further comprises processing 41B, by the processing circuitry 702, second parameter data 410B associated with the vehicle (10) and the second operation of the vehicle 10 to determine 42B a second pivot point P2 of the vehicle 10 changed from the first pivot point P2 and displaying 43B, by the processing circuitry 702, a second pivot point indicia PI2 associated with the second pivot point P2.

FIG. 16 is a schematic diagram of a computer system700 for implementing examples disclosed herein. The computer system 700 is adapted to execute instructions from a computer-readable medium to perform these and/or any of the functions or processing described herein. The computer system 700 may be connected (e.g., networked) to other machines in a LAN, an intranet, an extranet, or the Internet. While only a single device is illustrated, the computer system 700 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 700 may comprise at least one computing device or electronic device capable of including firmware, hardware, and/or executing software instructions to implement the functionality described herein. The computer system 700 may include processing circuitry 702 (e.g., processing circuitry including one or more processor devices or control units), a memory 704, and a system bus 706. The computer system 700 may include at least one computing device having the processing circuitry 702. The system bus 706 provides an interface for system components including, but not limited to, the memory 704 and the processing circuitry 702. The processing circuitry 702 may include any number of hardware components for conducting data or signal processing or for executing computer code stored in memory 704. The processing circuitry 702 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 702 may further include computer executable code that controls operation of the programmable device.

The system bus 706 may be any of several types of bus structures that may further interconnect to a memory bus (with or without a memory controller), a peripheral bus, and/or a local bus using any of a variety of bus architectures. The memory 704 may be one or more devices for storing data and/or computer code for completing or facilitating methods described herein. The memory 704 may include database components, object code components, script components, or other types of information structure for supporting the various activities herein. Any distributed or local memory device may be utilized with the systems and methods of this description. The memory 704 may be communicably connected to the processing circuitry 702 (e.g., via a circuit or any other wired, wireless, or network connection) and may include computer code for executing one or more processes described herein. The memory 704 may include non-volatile memory 708 (e.g., read-only memory (ROM), erasable programmable read-only memory (EPROM), electrically erasable programmable read-only memory (EEPROM), etc.), and volatile memory 710 (e.g., random-access memory (RAM)), or any other medium which can be used to carry or store desired program code in the form of machine-executable instructions or data structures and which can be accessed by a computer or other machine with processing circuitry 702. A basic input/output system (BIOS) 712 may be stored in the non-volatile memory 708 and can include the basic routines that help to transfer information between elements within the computer system 700.

The computer system 700 may further include or be coupled to a non-transitory computer-readable storage medium such as the storage device 714, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 714 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 714 and/or in the volatile memory 710, which may include an operating system 716 and/or one or more program modules 718. All or a portion of the examples disclosed herein may be implemented as a computer program 720 stored on a transitory or non-transitory computer-usable or computer-readable storage medium (e.g., single medium or multiple media), such as the storage device 714, which includes complex programming instructions (e.g., complex computer-readable program code) to cause the processing circuitry 702 to carry out actions described herein. Thus, the computer-readable program code of the computer program 720 can comprise software instructions for implementing the functionality of the examples described herein when executed by the processing circuitry 702. In some examples, the storage device 714 may be a computer program product (e.g., readable storage medium) storing the computer program 720 thereon, where at least a portion of a computer program 720 may be loadable (e.g., into a processor) for implementing the functionality of the examples described herein when executed by the processing circuitry 702. The processing circuitry 702 may serve as a controller or control system for the computer system 700 that is to implement the functionality described herein.

The computer system 700 may include an input device interface 722 configured to receive input and selections to be communicated to the computer system 700 when executing instructions, such as from a keyboard, mouse, touch-sensitive surface, etc. Such input devices may be connected to the processing circuitry 702 through the input device interface 722 coupled to the system bus 706 but can be connected through other interfaces, such as a parallel port, an Institute of Electrical and Electronic Engineers (IEEE) 1394 serial port, a Universal Serial Bus (USB) port, an IR interface, and the like. The computer system 700 may include an output device interface 724 configured to forward output, such as to a display, a video display unit (e.g., a liquid crystal display (LCD) or a cathode ray tube (CRT)). The computer system 700 may include a communications interface 726 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

According to an aspect a computer system, vehicle and method according to any of the following examples is provided.

Example 1: A computer system (700) comprising processing circuitry (702) configured to process (41A) first parameter data (410A) associated with a vehicle (10) and a first operation of said vehicle (10) to determine (42A) a first pivot point (P1) of the vehicle (10), display (43A) a first pivot point indicia (PI1) associated with the first pivot point (P1), process (41B) second parameter data (410B) associated with the vehicle (10) and a second operation of said vehicle (10) to determine (42B) a second pivot point (P2) of the vehicle (10) changed from the first pivot point (P1), and display (43B) a second pivot point indicia (PI2) associated with the second pivot point (P2).

Example 2: The computer system (700) of example 1, wherein the vehicle (10) comprises a trailer (11).

Example 3: The computer system (700) of example 2, wherein the vehicle (10) comprises one or more articulated trailer (11) and the processing circuitry (702) is configured to determine (42A-B) a first and second pivot point (P1, P2) and display (43A-B) a first and second pivot point indicia (PI1-2) for each articulated trailer (11).

Example 4: The computer system (700) of any of examples 1-3, wherein the processing circuitry (702) is configured to process (41A-B) the first and second parameter data (410A-B) to identify a current steering angle(S) of the vehicle (10) and a current driving direction (D) of the vehicle (10), and wherein the processing circuitry (702) is configured to determine (42A-B) the first and second pivot point (P1, P2) based on the current steering angle(S) and the current driving direction (D) of the vehicle (10).

Example 5: The computer system (700) of any of examples 1-4, wherein the processing circuitry (702) is configured to process (41A-B) the first and second parameter data (410A-B) to identify one or more load indicator value (LV) associated with the load distribution of the vehicle (10) and based on said one or more load indicator value (LV) determine (45A-B) a load distribution model (LVM) of the vehicle (10), and wherein the processing circuitry (702) is configured to determine (42A-B) the first and second pivot point (P1, P2) based on said load distribution model (LVM).

Example 6: The computer system (700) of example 5, wherein the one or more load indicator value (LV) comprises at least one of a value associated with the type of wheel axles of the vehicle (10), number of wheel axles of the vehicle (10), the position of the wheel axles of the vehicle (10), the load on the wheel axles of the vehicle (10), the status of one or more liftable wheel axles of the vehicle (10), the number of wheels of the vehicle (10) or the tire pressure of the tires of the vehicle (10).

Example 7: The computer system (700) of example 5 or 6, wherein the vehicle (10) comprises a trailer (11) with at least two rear wheel axles (61, 62) and the processing circuitry (702) is configured to process (41A-B) the first and second parameter data (41A-B) to identify a first load indicator value (LV1) associated with the load on a first rear wheel axle (61) of the trailer (11) and a second load indicator value (LV2) associated with the load on a second rear wheel axle (62) of the trailer (11) and determine (42A-B) the first and second pivot point (P1, P2) based on said first and second load indicator value (LV1, LV2).

Example 8: The computer system (700) of any of examples 1-7, wherein the processing circuitry (702) is configured to process (41A-B) the first and second parameter data (42A-B) to identify one or more geometrical indicator value (GV) associated with the geometry of the vehicle (10) and based on said one or more geometrical indicator value (GV) determine (46A-B) a geometrical model (GM) of the vehicle (10), and wherein the processing circuitry (702) is configured to determine (42A-B) the first and second pivot point (P1, P2) based on said geometrical model (GM).

Example 9: The computer system (700) of any of example 1-8, further comprising a user interface (90) comprising a display device (91), wherein the processing circuitry (702) is configured to display (43A-B) the first and second pivot point indicia (PI1-2) on said display device (91).

Example 10: A vehicle (10) comprising the computer system (700) of any one of examples 1-9.

Example 11: The vehicle (10) of example 10, further comprising a camera monitoring system (900) configured to monitor a zone in connection to the vehicle (10) and operatively connected to the computer system (700), wherein the processing circuitry (702) is configured to obtain an image feed (9000) from the camera monitoring system (900) and the processing circuitry (702) is configured to display (43A-B) the first and second pivot point indicia (PI1-2) as an overlay in said image feed (9000).

Example 12: The vehicle (10) of example 11, wherein the camera monitoring system (900) forms a part of a digital side view mirror system (941) and/or rearview mirror system (942).

Example 13: The vehicle (10) of any of examples 10-12, wherein the computer system (700) further comprises a user interface (90) comprising a display device (91), wherein the processing circuitry (702) is configured to display (43A-B) the first and second pivot point indicia (PI1-2) on said display device (91), the vehicle (10) further comprising a camera monitoring system (900) configured to monitor a zone in connection to the vehicle (10) and operatively connected to the user interface (90), wherein the display device (91) is configured to present an image feed from the camera monitoring system (900) and the processing circuitry (702) is configured to display the first and second pivot point indicia (PI1-2) as an overlay in said image feed (9000), wherein the camera monitoring system (900) forms a part of a digital side view mirror (941) and/or rearview mirror system (942), wherein the vehicle (10) comprises a trailer (11) and a tractor (12), wherein the trailer (11) is connected to the tractor (12) via an articulated connection, wherein the processing circuitry (700) is configured to process (41A-B) the first and second parameter data (410A-B) to identify a current steering angle(S) of the vehicle (10) and a current driving direction (D) of the vehicle (10) and identify one or more load indicator value (LV) associated with the current load distribution of the vehicle (10) and based on said one or more load indicator value (LV) determine a load distribution model (LVM) of the vehicle (10), whereby the processing circuitry (702) is configured to determine (42A-B) the first and second pivot point (P1, P2) based on the current steering angle(S) and the current driving direction (D) of the vehicle (10) and said load distribution model (LVM).

Example 14: A computer-implemented method (1000) comprising processing (41A), by processing circuitry (702) of a computer system (700), first parameter data (410A) associated with a vehicle (10) and a first operation of the vehicle (10) to determine (42A) a first pivot point (P1) of the vehicle (10), displaying (43A), by the processing circuitry (702), a first pivot point indicia (PI1) associated with the first pivot point (P1), processing (41B), by the processing circuitry (702), second parameter data (410B) associated with the vehicle (10) and a second operation of the vehicle (10) to determine (42B) a second pivot point (P2) of the vehicle (10) changed from the first pivot point (P2), and displaying (43B), by the processing circuitry (702), a second pivot point indicia (PI2) associated with the second pivot point (P2).

Example 15: The computer-implemented method (1000) of example 14, wherein the vehicle (10) comprises one or more articulated trailer (11), wherein the method further comprises determining (42A-B), by the processing circuitry (702), a first and second pivot point (P1, P2) for each articulated trailer (11), and displaying (43A-B), by the processing circuitry (702), a first and second pivot point indicia (PI1-2) for each articulated trailer (11).

Example 16: The computer-implemented method (1000) of example 14 or 15, further comprising processing (41A-B), by the processing circuitry (702), the first and second parameter data (410A-B) to identify a current steering angle(S) of the vehicle (10) and a current driving direction (D) of the vehicle (10), and determining (42A-B), by the processing circuitry (702), the first and second pivot point (P1, P2) based on the current steering angle(S) and the current driving direction (D) of the vehicle (10).

Example 17: The computer-implemented method (1000) of any of example 14-16, further comprising processing (41A-B), by the processing circuitry (702), the first and second parameter data (410A-B) to identify one or more load indicator value (LV) associated with the current load distribution of the vehicle (10), determining (45A-B), by the processing circuitry (702), a load distribution model (LVM) of the vehicle (10) based on the one or more load indicator value (LV), and determining (42A-B), by the processing circuitry (702), the first and second pivot point (P1, P2) based on the load distribution model (LVM).

Example 18: The computer-implemented method (1000) of any of example 14-17, further comprising processing (41A-B), by the processing circuitry (702), the first and second parameter data (410A-B) to identify one or more geometrical indicator value (GV) associated with the geometry of the vehicle (10), determining (46A-B), by the processing circuitry (702), a geometrical model (GM) of the vehicle (10) based on said one or more geometrical indicator value (GV) and determining (42A-B), by the processing circuitry (702), the first and second pivot point (P1, P2) based on said geometrical model (GM).

Example 19: A computer program product (600) comprising program code (610) for performing, when executed by the processing circuitry (702), the method (1000) of any of examples 14-18.

Example 20: A non-transitory computer-readable storage medium (500) comprising instructions, which when executed by the processing circuitry (702), cause the processing circuitry (702) to perform the method (1000) of any of example 14-18.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
process first parameter data associated with a vehicle and a first operation of said vehicle to determine a first pivot point of the vehicle;
display a first pivot point indicia associated with the first pivot point;
process second parameter data associated with the vehicle and a second operation of said vehicle to determine a second pivot point of the vehicle changed from the first pivot point, and
display a second pivot point indicia associated with the second pivot point.

2. The computer system of claim 1, wherein the vehicle comprises a trailer.

3. The computer system of claim 2, wherein the vehicle comprises one or more articulated trailer and the processing circuitry is configured to determine a first and second pivot point and display a first and second pivot point indicia for each articulated trailer.

4. The computer system of claim 1, wherein the processing circuitry is configured to process the first and second parameter data to identify a current steering angle of the vehicle and a current driving direction of the vehicle, and wherein the processing circuitry is configured to determine the first and second pivot point based on the current steering angle and the current driving direction of the vehicle.

5. The computer system of claim 1, wherein the processing circuitry is configured to process the first and second parameter data to identify one or more load indicator value associated with the load distribution of the vehicle and based on said one or more load indicator value determine a load distribution model of the vehicle, and wherein the processing circuitry is configured to determine the first and second pivot point based on said load distribution model.

6. The computer system of claim 5, wherein the one or more load indicator value comprises at least one of a value associated with the type of wheel axles of the vehicle, number of wheel axles of the vehicle, the position of the wheel axles of the vehicle, the load on the wheel axles of the vehicle, the status of one or more liftable wheel axles of the vehicle, the number of wheels of the vehicle or the tire pressure of the tires of the vehicle.

7. The computer system of claim 5, wherein the vehicle comprises a trailer with at least two rear wheel axles and the processing circuitry is configured to process the first and second parameter data to identify a first load indicator value associated with the load on a first rear wheel axle of the trailer and a second load indicator value associated with the load on a second rear wheel axle of the trailer and determine the first and second pivot point based on said first and second load indicator value.

8. The computer system of claim 1, wherein the processing circuitry is configured to process the first and second parameter data to identify one or more geometrical indicator value associated with the geometry of the vehicle and based on said one or more geometrical indicator value determine a geometrical model of the vehicle, and wherein the processing circuitry is configured to determine the first and second pivot point based on said geometrical model.

9. The computer system of claim 1, further comprising a user interface comprising a display device, wherein the processing circuitry is configured to display the first and second pivot point indicia on said display device.

10. A vehicle comprising the computer system of claim 1.

11. The vehicle of claim 9, further comprising a camera monitoring system configured to monitor a zone in connection to the vehicle and operatively connected to the computer system, wherein the processing circuitry is configured to obtain an image feed from the camera monitoring system and the processing circuitry is configured to display the first and second pivot point indicia as an overlay in said image feed.

12. The vehicle of claim 11, wherein the camera monitoring system forms a part of a digital side view mirror system and/or rearview mirror system.

13. The vehicle of claim 10, wherein the computer system further comprises a user interface comprising a display device, wherein the processing circuitry is configured to display the first and second pivot point indicia on said display device,
the vehicle further comprising a camera monitoring system configured to monitor a zone in connection to the vehicle and operatively connected to the user interface, wherein the display device is configured to present an image feed from the camera monitoring system and the processing circuitry is configured to display the first and second pivot point indicia as an overlay in said image feed,
wherein the camera monitoring system forms a part of a digital side view mirror and/or rearview mirror system,
wherein the vehicle comprises a trailer and a tractor, wherein the trailer is connected to the tractor via an articulated connection,
wherein the processing circuitry is configured to process the first and second parameter data to identify a current steering angle of the vehicle and a current driving direction of the vehicle and identify one or more load indicator value associated with the current load distribution of the vehicle and based on said one or more load indicator value determine a load distribution model of the vehicle,
whereby the processing circuitry is configured to determine the first and second pivot point based on the current steering angle and the current driving direction of the vehicle and said load distribution model.

14. A computer-implemented method comprising;
processing, by processing circuitry of a computer system, first parameter data associated with a vehicle and a first operation of the vehicle to determine a first pivot point of the vehicle;
displaying, by the processing circuitry, a first pivot point indicia associated with the first pivot point;
processing, by the processing circuitry, second parameter data associated with the vehicle and a second operation of the vehicle to determine a second pivot point of the vehicle changed from the first pivot point, and
displaying, by the processing circuitry, a second pivot point indicia associated with the second pivot point.

15. The computer-implemented method of claim 14, wherein the vehicle comprises one or more articulated trailer, wherein the method further comprises determining, by the processing circuitry, a first and second pivot point for each articulated trailer, and displaying, by the processing circuitry, a first and second pivot point indicia for each articulated trailer.

16. The computer-implemented method of claim 14, further comprising:
processing, by the processing circuitry, the first and second parameter data to identify a current steering angle of the vehicle and a current driving direction of the vehicle, and
determining, by the processing circuitry, the first and second pivot point based on the current steering angle and the current driving direction of the vehicle.

17. The computer-implemented method of claim 14, further comprising:
processing, by the processing circuitry, the first and second parameter data to identify one or more load indicator value associated with the current load distribution of the vehicle;
determining, by the processing circuitry, a load distribution model of the vehicle based on the one or more load indicator value; and
determining, by the processing circuitry, the first and second pivot point based on the load distribution model.

18. The computer-implemented method of claim 14, further comprising processing, by the processing circuitry, the first and second parameter data to identify one or more geometrical indicator value associated with the geometry of the vehicle, determining, by the processing circuitry, a geometrical model of the vehicle based on said one or more geometrical indicator value and determining, by the processing circuitry, the first and second pivot point based on said geometrical model.

19. A computer program product comprising program code for performing, when executed by the processing circuitry, the method of claim 14.

20. A non-transitory computer-readable storage medium comprising instructions, which when executed by the processing circuitry, cause the processing circuitry to perform the method of claim 14.
